(19) United States
(12) Patent Application Publication
(10) Pub. No.: US 2011/0265515 A1
(43) Pub. Date: Nov. 3, 2011

(54) METHOD AND SYSTEM FOR BENDING GLASS SHEETS WITH COMPLEX CURVATURES

(76) Inventors: Alberto Hernandez Delsol, Nuevo León (MX); Jesús Alberto Gonzalez Rodriguez, Nuevo León (MX); Miguel Arroyo Ortega, Nuevo León (MX)

(21) Appl. No.: 13/139,871

(22) PCT Filed: Dec. 18, 2009
(86) PCT No.: PCT/MX09/00138

§ 371 Date: Jul. 15, 2011

Related U.S. Application Data
(60) Provisional application No. 61/193,766, filed on Dec. 22, 2008.

(51) Int. Cl. C03B 23/023; C03B 23/03

(52) U.S. Cl. 65/29.18; 65/106; 65/273; 65/158

(57) ABSTRACT

The present invention is related a method and a system for bending glass sheets with complex curvatures comprising: heating at least a pre-selected area of at least a glass sheet using microwave energy and then superficially forming the sheet against a die.

### BACKGROUND OF THE INVENTION

A. Field of the Invention

This invention relates to a method and system for bending glass sheets by heating selectively areas of the sheets using microwave energy and then superficially forming the sheets against a male die

B. Description of the Related Art

Currently there are several techniques for shaping and forming glass sheets such as automotive glasses, consisting mainly on heating the glasses using infrared (IR) heating elements. The IR energy heats the glass up to its softening point, allowing the glass sagging by gravity and conforming it to a mould shape. This mould could be a metal ring with the final glass shape. Another method is the so known press bending method, wherein two forming dies shape the glass to a desired curvature.

The methods described above are considered improper to obtain complex curvatures due to the fact that the entire glass surface is evenly heated, causing that the areas in contact with the mould get damaged, in detriment to the optical quality.

The use of focalized IR radiation to selectively heat the glass has the disadvantage that the focused radiation firstly heats the glass surface and subsequently the rest of the mass through its thickness, resulting in an uneven heating of the glass and a soft surface.

The smooth curvature that the glass can acquire during the preheating step is a limitation for the press die process. This limitation has the inconvenience of creating secondary effects when trying to additionally heat the glass to facilitate the press die shaping.

State of the art for focalized heat using microwaves, like the one described on WO2008/090087A1 does not take in account that there are other variables that influence the glass shaping besides the heat application and the glass weight. Inventors have noticed that also the bending fixture or mould is and important factor to be considered for a good glass shaping.

Based on the issues above, the present invention is a method to accomplish complex curvatures on two sheets of glass by pressing the glass against a die like the one described on U.S. Pat. No. 5,713,976, but additionally the glass has been previously heated selectively on those areas that require a complex curvature, and avoiding to unnecessarily overheating the other zones of the glass sheets like, for instance, the glass area in contact with the pre-forming mould, resulting in favor of less surface deformation knowing that the glass surface deformation is one of the most important causes of optical defects.

With the above described and proposed method, final shape repeatability of the glass will not depend upon all the bending fixtures or moulds typically used in a continuous shaping process.

A continuous bending process could use in a range of 40 to 50 moulds, where all of them need to be calibrated and well maintained to avoid product variation.

It is important to notice that in the proposed method; only the press die will be required to be kept calibrated in order to meet product requirements.

From a continuous lehr conventional bending process revision, wherein the glass is curved by the gravity effect or by press bending, we have detected the need of differentially softening the glass, on pre-defined areas, to facilitate the shaping of small radius or complex curvatures that will not be feasible by the gravity shaping process itself, dependant only of the glass visco-elastic phase properties.

The use of a press forming process is limited due to the damage caused on the glass surface that is in contact with the press die. However, if the temperature on those areas is controllably limited to those zones where the complex curvature is required, then the superficial damage is avoided, because the glass is not too soft on those contact points

### SUMMARY OF THE INVENTION

It is therefore a main object of the invention, to provide a method and a system for bending a glass sheet by heating it selectively on specific areas of the sheet, while it is on top of pre-forming mould, using microwave energy and then forming the glass sheet with a male die to obtain controlled curvatures.

It is also a main object of the invention, to provide a method and system for bending glass with complex curvatures, of the above referred nature, that is free of superficial or optical distortion caused by the contact of softened glass against the bending ring and/or the male die.

It is also a main object of the invention to provide a method and system to selectively heat the glass sheet by the use of an apparatus to manage the microwave positioning and a controlled energy application to obtain a desired heating pattern.

It is a further main object of the present invention, to provide a method an system for bending glass with complex curvatures, that eliminates the need to control precisely all bending rings shape and instead only the male die shape is precisely calibrated to meet product requirements.

An additional main object of the present invention is to provide a method and a system where the male die has the possibility to be calibrated by the addition of an adjusting structure to the male die construction.

### BRIEF DESCRIPTION OF THE DRAWINGS

FIG. 1 is a schematic diagram of the method steps in relation with the system for bending glass with complex curvatures, in accordance with a preferred embodiment of the present invention;

FIG. 2 are examples showing the way of heat application in an automotive windshield glass;

FIG. 3 is a schematic diagram detailing the steps of the glass pressing method.

### DETAILED DESCRIPTION OF THE INVENTION

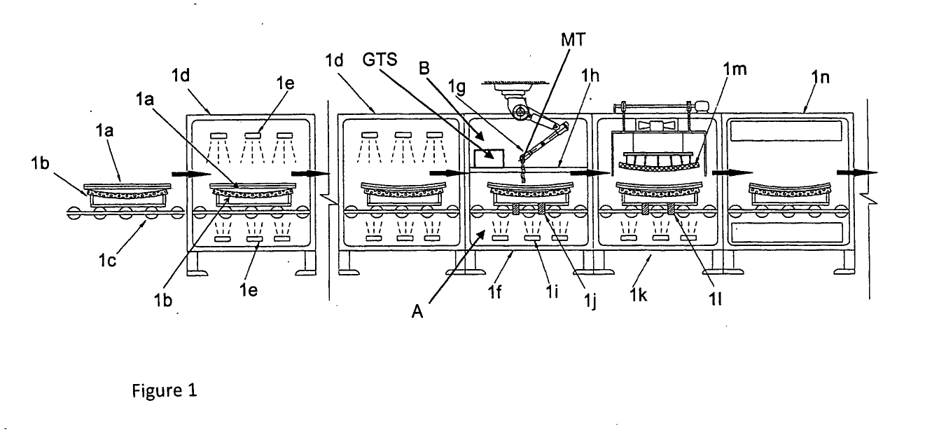

The method and system for bending glass with complex curvatures in accordance with the present invention will be now described with reference to the preferred embodiments thereof, illustrated in the enclosed drawings wherein the same numbers refer to the same parts of the shown drawings. Referring to FIG. 1, the method for bending glass with complex curvatures, of the present invention, comprises the following steps:
1. Placing an automotive windshield glass 1a, currently comprised by two glass sheets 1a on a pre-forming mould 1b holding the glass 1a horizontally, supported by a ring and mounted on a moving roller conveyor 1c;
2. Moving the glass 1a on the mold 1b, through a pre-heating chamber 1d;
3. Introducing the glass and pre-forming mould on a microwave chamber 1f below microwave transmitters MT and a moving mechanism 1g and centering it by means of a first centering mechanism 1j to be selectively heated;
4. Moving the glass 1a and the pre-forming mould 1b to a press forming station 1k where the pre-forming mould is centered by a second centering mechanism 11 below a pressing die 1m to be shaped;
5. Moving the glass 1a and the pre-forming mould 1b through a annealing and cooling chamber 1n.

The glass 1a and the pre-form mould 1b enter the pre-heating chamber 1d, which is equipped with infrared elements 1e positioned over and below the glass sheet 1a that generate infrared radiation.

The pre-heating chamber 1d characteristics as length, cross section, and heating elements dimensions are calculated according to the desired cycle time and glass mass load.

The glass is heated from ambient temperature up to its softening point from about 500° C. to about 620° C. along the travel through the pre-heating chamber 1d.

On the final section of pre-heating 1d, the glass will acquire certain curvature by effect of gravity, temperature and the pre-form mould 1b.

Then, the softened glass enters into the microwave chamber 1f where is positioned below the microwave transmitters MT and their corresponding moving mechanisms 1g. Microwave transmitters MT emit microwave energy, in the range of 0.9 to 10 GHZ.

Glass 1a and pre-form mould 1b are positioned and kept in place by means of a centering mechanism 1j located at the rollers level on the conveyor 1c.

Energy is applied on glass zones GZ previously specified and that depend on the temperature distribution required for the following pressing process.

IR (infrared radiation) heating elements 11 are installed inside this heating chamber 1f to keep a chamber temperature favorable for the process and avoid glass cooling at this stage.

The microwave energy application allows the glass to reach temperature differentials in the range of about 20 to about 50° C. in a short time compared to other methods of heating.

The microwave energy can be focalized by the means of microwave transmitters MT mounted on a moving mechanisms 1g that can help to move them with accuracy over the desired zones of heat application.

The heating chamber 1f section includes a first chamber B for maintaining the temperature of the glass sheet 1a between about 500° C. to about 620° C. (first predetermined temperature) and to receive an increasing of temperature from about 20° C. to about 50° C. over the first predetermined temperature and a second chamber B to maintain a temperature between 40° C. and 90° C., said second chamber including a moving mechanism 1g to be moved selectively to each pre-selected area, said moving mechanism including microwave transmitters MT mounted on the same.

The moving mechanism 1g and transmitters MT are isolated from the heating chamber 1f (a microwave chamber) where the glass is, by the means of ceramic panels 1h, taking advantage of it property of being transparent to the microwave when its temperature is above 600°. This condition helps to increase the moving mechanism 1g and transmitter MT life and the access to maintenance and service without the need of shutting down the furnace.

The ceramic panels 1h is placed between the moving mechanism 1g and the glass sheet, 1a, said ceramic plate 1h allowing the transmission of the microwave energy from the transmitters MT on the glass sheet 1a.

Microwave energy is applied to previously defined patterns on areas GZ that will demand more effort to conform to the press die form 1m, as those with small radius.

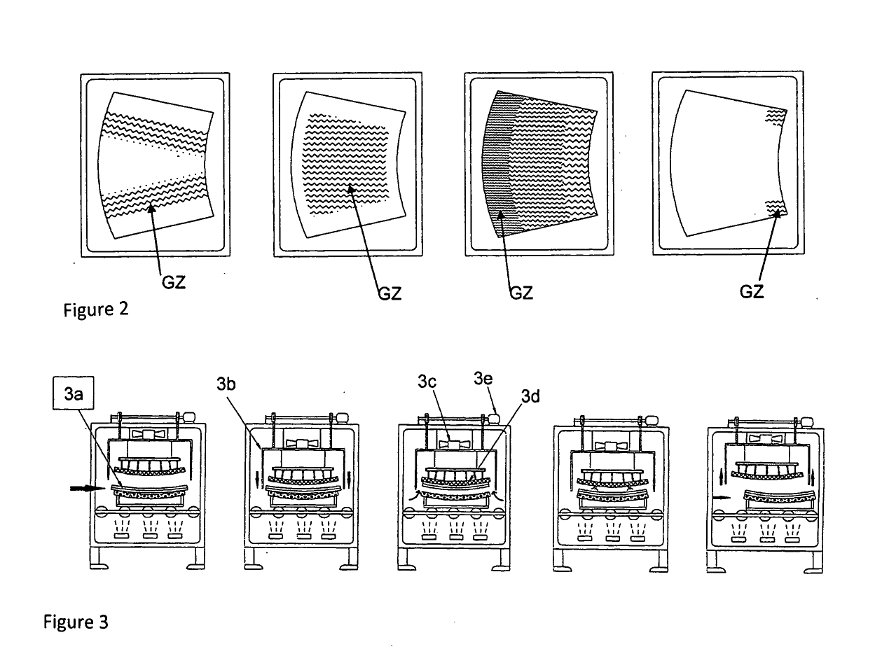

FIG. 2 illustrates some microwave heating patterns examples GZ required to prepare the glass for the press forming with the male die 1m. The microwave heating patterns will increase the glass temperature as desired by controlling the scanning speed, time and power.

The moving mechanism 1g allows the transmitter MT to have at least four degrees of freedom and can be or not a robot.

The control of the glass temperature is a closed loop control between the glass temperature scanner GTS and a microwave controller 3e in order to regulate parameters as time and power application.

The microwave energy in a first embodiment of the present invention is applied under the following steps:

The glass sheet 1a is scanned to measure its temperature distribution after said glass sheet has be heated between a temperature of between 500° C. and between 620° C. (first predetermined temperature); after microwave energy is applied to each of the pre-selected area GZ of the glass sheet 1a, to heat the pre-selected area GZ in a temperature between about 20° C. and about 50° C. over the 500° C. and 620° C. Once that each pre-selected area has being heated, the scanner GTS apply a second scanning step on the glass sheet 1a, to confirm the glass temperature. The application of the microwave energy is controlled by a temperature scanner, power and/or frequency control and/or time.

The differentially heated glass then moves to the next station where the final shaping process is being performed.

On the press forming station illustrated on FIG. 3, as a first step, the glass and pre-form mould 3a are positioned and steady in the center of the zone by means of a mechanic and pneumatic centering device located at rollers level, then, as a second step, the upper chamber 3b moves down and a vacuum flow is activated by means of a vacuum generator 3c, which will lift the two pieces of glass at the same time (third step), pressing the glass sheets 1a against the male die 3d located in the center of the vacuum chamber.

The male die 3d is a steel plate formed to final product curvature supported on a structure that allows to manually adjusting the die surface to meet the product profile along its entire surface shape.

Both the vacuum chamber 3c and the male die 3d are moved up and down with accuracy by an electronic controlled mechanism 3e located over the module structure.

As a fourth step, the vacuum is turned off and a small amount of hot air is blown in the center of the male die 3d in order to facilitate glass release from the male die. Glass is then deposited over the pre-form mould 3a.

On the final step (fifth), the vacuum chamber 3c is lifted along with the male die 3d to allow the glass and pre-form mould 3a to continue its travel to annealing and cooling chambers (not shown).

The moving roller conveyor 1c including a series of rollers R that rotate in a desired direction to introduce the glass sheet to each of said preheating, heating, molding and cooling sections.

From the above, a method and system for bending glass with complex curvatures has been described and will apparent for the experts in the art that many other features or improvements can be made, which can be considered within the scope determined by the following claims.

We claim:

1. A method for bending glass sheets with complex curvatures comprising: heating at least a pre-selected area of at least a glass sheet using microwave energy and then superficially forming the sheets against a die.

2. A method for bending glass sheets with complex curvatures as claimed in claim 1, wherein the step of heating of pre-selected areas of the glass sheets comprises:
a. Preheating at least a glass sheet to a first predetermined temperature on a pre-forming mould, holding the glass sheet horizontally and being mounted to be moved on a moving roller conveyor,
b. Applying microwave energy in at least a pre-selected area of the glass sheet to provide heat to said pre-selected area to a second predetermined temperature;
c. Molding the glass sheets against a die;
d. Cooling the glass sheets to a third pre-selected temperature.

3. A method for bending glass sheets with complex curvatures as claimed in claim 2, wherein the step of applying microwave energy includes the steps of:
a. Scanning the glass temperature distribution on the glass sheet, after said glass sheet has be heated to the first predetermined temperature;
b. Applying microwave energy to the pre-selected area of the glass sheet;
c. Applying a second scanning on the glass sheet to confirm the glass temperature distribution; and,
d. Regulating the microwave energy to accomplish the required temperature and to provide the appropriate temperature for the pressing of the glass sheet.

4. A method for bending glass sheets with complex curvatures as claimed in claim 3, wherein the application of the microwave energy is controlled by a temperature scanner, power and/or frequency control and/or time.

5. The method for bending glass sheets of claim 2, wherein the molding of the glass sheet is carried out by pressing the glass by means of vacuum against the die.

6. The method for bending glass sheets of claim 2, wherein the molding of the glass sheet is carried out by means of pressing the glass sheet against the die.

7. The method for bending glass sheets, of claim 2, wherein the glass is pre-selected heated by the microwave energy on those zones where pressing effort need to be minimized to avoid glass surface damage.

8. The method for bending glass sheets of claim 2 wherein the die is a male die.

9. The method for bending glass sheets of claim 8 wherein male die is calibrated by means of an adjusting structure

10. The method on claim 2, wherein the heating by microwave energy is carried out by means of microwave transmitters mounted on a moving mechanism.

11. The method on claim 2, wherein the microwave energy is a frequency within a range of about 0.9 Ghz to about 10 Ghz.

12. The method on claim 2, wherein the first pre-determined temperature is a temperature within the range of about 500° C. and about 620° C.

13. The method on claim 2 wherein the second pre-determined temperature is increased up between about 20° C. and between about 50° C. over the first predetermined temperature.

14. A system for bending glass sheets with complex curvatures comprising:
a) A preheating section for horizontally supporting at least a glass sheet, said glass sheet being supported by a ring and mounted on a moving roller conveyor, said preheating section being adapted to raise the temperature of the glass sheet to a first predetermined temperature
b) A heating section having at least a microwave energy source positioned over the glass sheet to heat at least a pre-selected area of the glass sheet to a second predetermined temperature;
c) A molding section for molding the glass sheets against a die, and,
d) A cooling section for cooling the glass sheets to a third pre-selected temperature.

15. The system for bending glass sheets with complex curvatures as claimed in claim 14, wherein the system includes a scanner apparatus to carry out a first scanning the glass temperature distribution on the glass sheet, after said glass sheet has be heated to the first predetermined temperature, and to apply a second scanning on the glass sheet to confirm the glass temperature distribution.

16. The system for bending glass sheets of claim 14 wherein the heating section includes a first chamber for maintaining the first predetermined temperature of the glass sheet and to receive an increasing of temperature between about 20° C. and about 50° C. over the first predetermined temperature and a second chamber to maintain a temperature between 40° C. and 90° C., said second chamber including a moving mechanism to be moved selectively to each pre-selected area, said moving mechanism including microwave transmitters mounted on the same.

17. The system for bending glass sheets of claim 14 wherein the first predetermined temperature is within a range between about 500° C. and about 620° C.

18. The system for bending glass sheets with complex curvatures as claimed in claim 14 wherein the microwave energy source emits a frequency within a range of about 0.9 Mhz (Ghz) to about 10 Mhz (Ghz).

19. The system for bending glass with complex curvatures as claimed in claim 14 wherein the preheating section includes infrared elements positioned over and below the glass sheet to heat the glass sheet to the first predetermined temperature.

20. The system for bending glass sheets of claim 14 wherein the die is a male die.

21. The system for bending glass sheets of claim 20 wherein male die is calibrated by means of an adjustable structure

22. The system for bending glass sheets of claim 14 wherein the die having comprises a predetermined curvature in accordance with the desired curvature for the glass sheet.

23. The system for bending glass sheets of claim 14 wherein the die is mounted on an adjustable structure, said structure being adjustable for molding the glass by means of vacuum against the die.

24. The system for bending glass sheets of claim 16 wherein the second chamber is an insolated chamber to keep insolated the moving mechanism and microwave transmitters from the high temperature of the first chamber, the insolated chamber including a ceramic plate placed between the moving mechanism and the glass sheet, said ceramic plate allowing the transmission of the microwave energy from the transmitters on the glass sheet.

25. The system for bending glass sheets of claim 14 wherein the pre-heating, heating, molding and cooling section includes a series of rollers that rotate in a desired direction to introduce the glass sheet to each of said sections.

26. The system for bending automotive glass sheets with complex curvatures as claimed in claim 21, wherein the die and the adjustable structure, are moved in different pressing cycle by electronic means.
